(19) United States
(12) Patent Application Publication
(10) Pub. No.: US 2018/0086314 A1
(43) Pub. Date: Mar. 29, 2018

(54) ADAPTER CONSTITUTING A WIPER SYSTEM

(71) Applicant: Valeo Systèmes d'Essuyage, Le Mesnil Saint Denis (FR)

(72) Inventors: Stéphane Houssat, Issoire (FR); Vincent Gaucher, Issoire (FR); Olivier Jomard, Issoire (FR)

(73) Assignee: Valeo Systèmes d'Essuyage, Le Mesnil Saint Denis (FR)

(21) Appl. No.: 15/718,844

(22) Filed: Sep. 28, 2017

(30) Foreign Application Priority Data
Sep. 29, 2016 (FR) 1659354

(51) Int. Cl. B60S 1/40

(52) U.S. Cl. CPC B60S 1/4048; B60S 2001/4054; B60S 2001/4051

(57) ABSTRACT

The invention relates to an adapter (2) which is intended to be fitted to an end portion of a drive arm, the adapter (2) comprising at least one front portion (11), at least one section of which is arranged in a U-shaped manner and which comprises a front upper wall (11a) and two front lateral walls (11b), the adapter (2) comprising at least one rear portion (12), at least one section of which is arranged in a U-shaped manner and which comprises a rear upper wall (12a) and two rear lateral walls (12b), characterised in that the front portion (11) and the rear portion (12) are articulated to each other by way of an articulation means (13) which is interposed between the front upper wall (11a) and the rear upper wall (12a).

The present invention relates to wiper systems for a motor vehicle and more particularly relates to an adapter which constitutes such a wiper system.

A wiper system, commonly referred to as a windscreen wiper, for a motor vehicle is configured to remove, by wiping, the liquids and dirt which may impede the vision which a driver of the motor vehicle has of his environment. These windscreen wipers generally comprise a drive arm which carries out an angular back-and-forth movement about a rotation axis, and an elongate wiper blade which is provided with a scraper blade which is produced from a resilient material. By rubbing against a front or rear glass surface of the motor vehicle, the scraper blade wipes the water and a given number of pieces of dirt therefrom and discharges them outside the field of vision of the driver.

Whatever the configuration of the wiper blade, that is to say, either a wiper blade comprising articulated callipers which retain the scraper blade in a plurality of different zones, or a wiper blade comprising a metal blade which maintains the scraper blade over the entire length thereof, the wiper blade is attached to an end portion of the drive arm by means of a connection device which comprises a connector which is mounted so as to be fixedly joined to the wiper blade.

In a first known embodiment, an adaptor which is capable of being assembled with the connector of the wiper blade is mounted so as to be movable by tilting about a fixing axis on the end portion of the drive arm. This first connection method is commonly used for windscreen wipers which are intended for glass surfaces which are located at the front of the motor vehicle. In a second known connection method, the connector is connected to a shaft which is fixedly joined to the drive arm. This second connection method is commonly encountered in windscreen wipers which are intended for the glass surfaces located at the rear of the motor vehicle.

The closest prior art is formed by the document US2013/0239356A1 which describes a fixing device which comprises a connector which carries the wiper blade and an adapter for connecting the connector to an end portion of the drive arm.

A general problem posed in the field involves the need to provide an adapter which is capable of cooperating effectively and durably with an end portion of the drive arm and which is capable of having a varied formation.

More specifically, it is desirable to provide an adapter which allows maintenance operations of the wiper system which are simple and rapid in order to allow an inexperienced user to carry them out readily. It is particularly desirable that an operation for replacing a worn wiper blade with a new wiper blade can be carried out readily and without any risk of damage to the connection device and more particularly the adapter.

Even more specifically, it is desirable to provide an adapter which prevents inadvertent unlocking of the adapter which is fitted to the end portion of the drive arm during use of the wiper system which is moved over the glass surface.

An object of the present invention is to provide an adapter which is arranged to allow simple and rapid maintenance operations while participating in a robust and permanent connection between a wiper blade and an end portion of the drive arm.

An adapter of the present invention is an adapter which is intended to be fitted to an end portion of a drive arm. The adapter comprises at least one front portion, at least one section of which is arranged in a U-shaped manner and which comprises a front upper wall and two front lateral walls. The adapter comprises at least one rear portion, at least one section of which is arranged in a U-shaped manner and which comprises a rear upper wall and two rear lateral walls.

According to the present invention, the front portion and the rear portion are articulated to each other by way of an articulation means which is interposed between the front upper wall and the rear upper wall.

The adapter advantageously comprises at least one of the following features, taken alone or together:

the front portion and the rear portion are aligned in accordance with a longitudinal axis of the adapter,

the front portion comprises a body and a front end, the body being connected to the rear portion by way of the articulation means,

the front end and the body are delimited by a border which overhangs the body,

the border is provided with at least one hook,

the adapter comprises a rotation means which is configured to connect the adapter to a connector,

the rear upper wall is provided with a button which is provided with a tooth,

at least one rear lateral wall is provided with a groove which is delimited at least by a ramp,

the adapter is provided with an actuation means for the rear portion.

The present invention also relates to a connection device which is formed by a connector and such an adapter.

The present invention also relates to a drive arm comprising at least one end portion which is U-shaped and which is delimited by a first wall and by two second walls which delimit an internal volume in which there is received such an adapter or such a connection device.

Preferably, the first wall is provided with a receiving hole for a button which is provided with a tooth, the hole comprising a front transverse edge against which the button abuts, the tooth extending above the first wall.

The present invention also relates to a wiper system which comprises such a drive arm, a connector which is fixedly joined to a wiper blade and such an adapter which connects the connector to the drive arm for rotation.

The present invention also relates to an assembly method for such an adapter with an end portion of a drive arm in which the assembly method comprises:

a first step of placing a border of the adapter in contact against a front edge of a first wall of the end portion,

a second step which involves a rotation of the adapter with respect to the end portion about the contact between the border and the front edge carried out during the first step,

a fifth step in which a tooth of a button of the adapter overcomes the first wall and extends thereabove.

Preferably, there is provision between the second step and the fifth step alternatively or cumulatively for:

a third step which involves manual locking of the adapter in the end portion,

a fourth step which involves automatic locking of the adapter in the end portion.

Other features, details and advantages of the invention will be appreciated more clearly from a reading of the following description which is given by way of example with reference to drawings, in which:

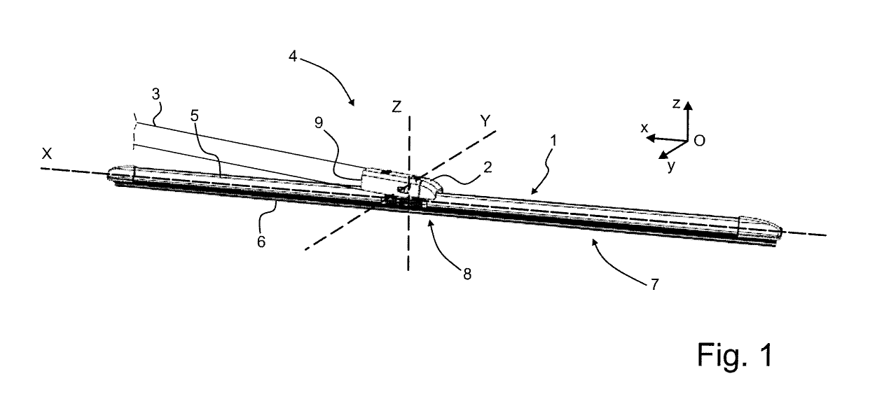

FIG. 1 is a perspective view of a wiper system according to the invention,

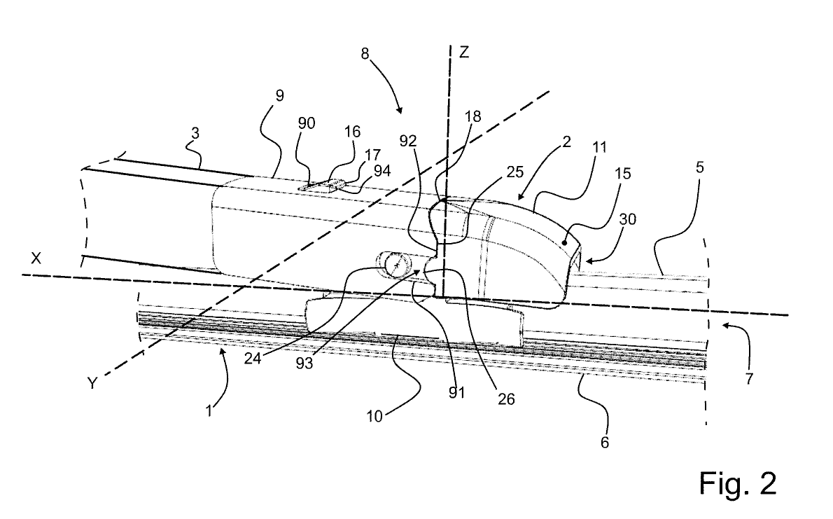

FIG. 2 is a view of a connection device of the present invention involved in the wiper system illustrated in FIG. 1,

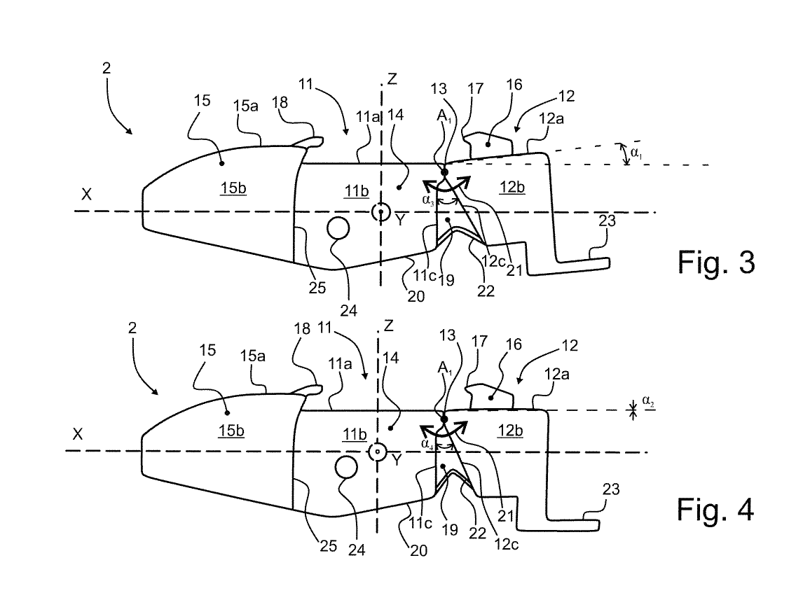

FIG. 3 is a side view of an adapter which constitutes the connection device illustrated in FIG. 2 and which is illustrated in a rest position,

FIG. 4 is a side view of the adapter which is illustrated in FIG. 3 and which is illustrated in a position for use,

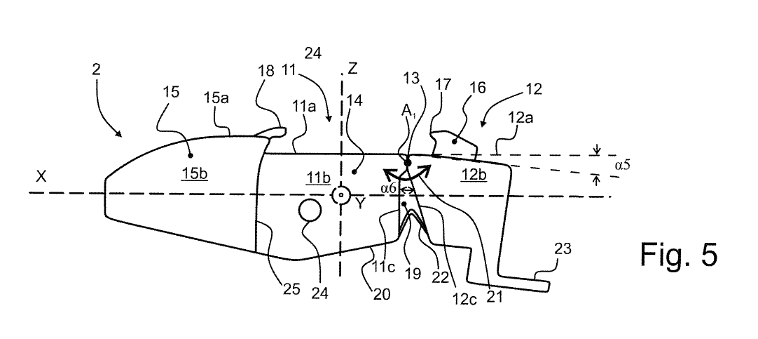

FIG. 5 is a side view of the adapter which is illustrated in FIGS. 3 and 4 and which is illustrated in an assembly position,

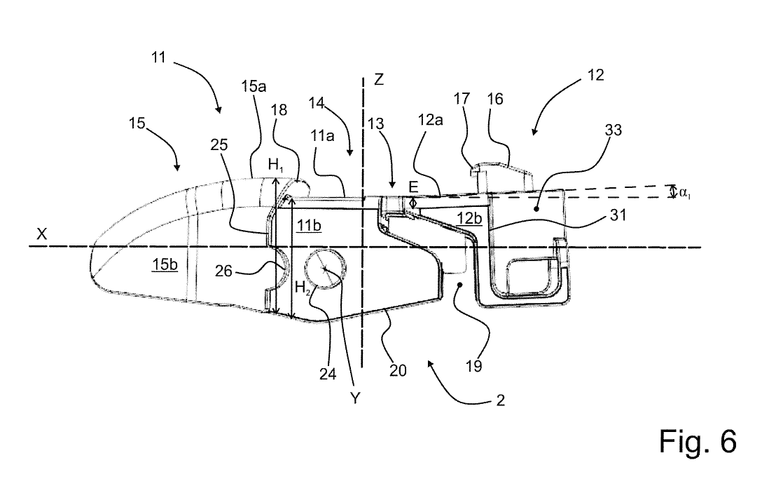

FIG. 6 is a side view of a construction variant of the adapter which is illustrated in FIGS. 3 to 5,

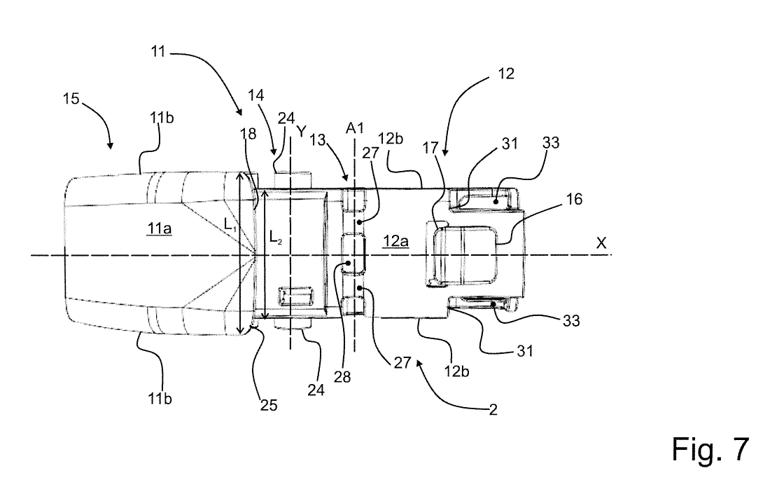

FIG. 7 is a top view of the adapter which is illustrated in FIG. 6,

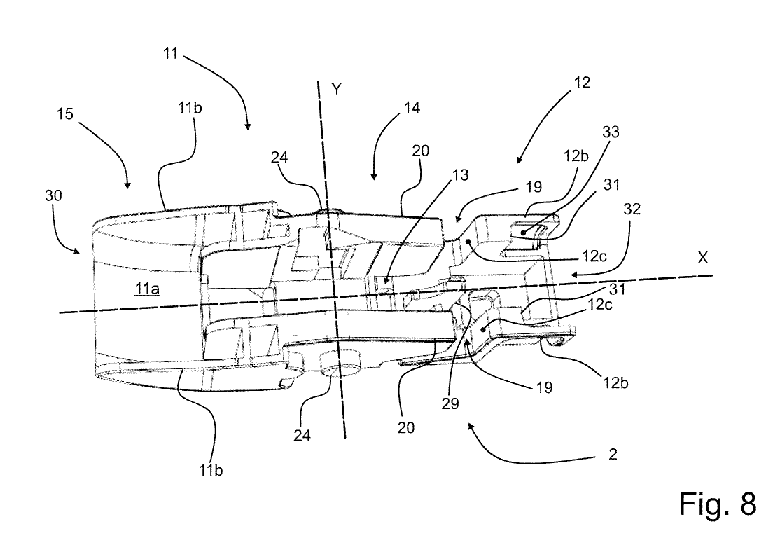

FIG. 8 is a perspective bottom view of the adapter illustrated in FIGS. 6 and 7,

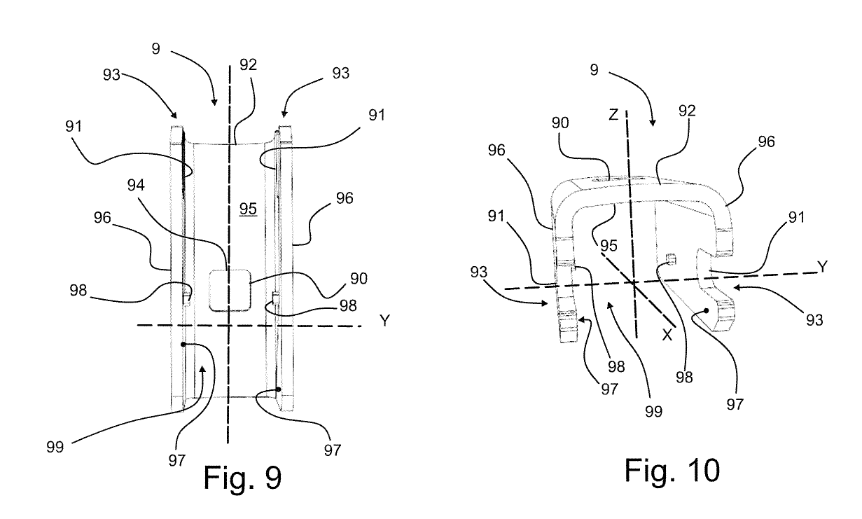

FIG. 9 is a bottom view of an end portion of a drive arm which is involved in the wiper system illustrated in FIG. 1,

FIG. 10 is a perspective front view of the end portion illustrated in FIG. 9,

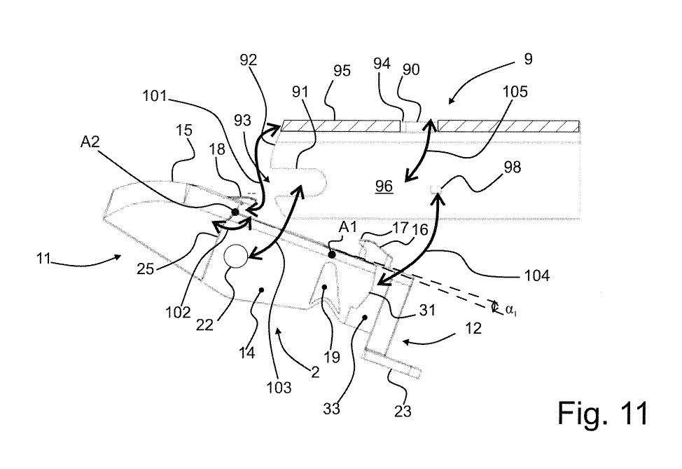

FIG. 11 is a schematic illustration of the steps of an assembly method for the adapter illustrated in FIGS. 3 to 7 on the end portion of the drive arm illustrated in FIGS. 9 and 10.

In the Figures, the terms longitudinal, transverse, vertical, lateral, front, rear, left, right, upper, lower, are intended to refer to the orientation of a wiper blade 1 illustrated in FIG. 1. A longitudinal direction corresponds to a longitudinal axis X, along which the wiper blade 1 and/or an adapter 2 of the present invention extend(s). A transverse direction corresponds to the direction of a transverse axis Y which is perpendicular to the longitudinal axis X. The terms left and right are intended to be understood to be in relation to a position along the transverse axis Y, at one side and the other of the longitudinal axis X. A vertical direction parallel with the direction of a vertical axis Z is perpendicular to the longitudinal and transverse directions mentioned above. The terms upper or lower relate to orientations parallel with the vertical axis Z the term lower containing the plane of the windscreen. For the longitudinal directions, the terms external or internal are intended to be understood to be in relation to a pivot location of the wiper blade 1 on a drive arm 3 of the wiper blade 1, the term internal corresponding to the portion in which the drive arm 3 and a half-wiper extend, the term external corresponding to the portion in which the other half-blade extends.

The directions set out above are illustrated in an orthonormal reference system Oxyz which is illustrated in the Figures. In this reference system, the axis Ox represents the longitudinal direction, the axis Oy represents the transverse direction and the axis Oz represents the vertical direction.

In FIG. 1, a motor vehicle is commonly provided with a wiper system 4 in order to discharge water and/or dirt which are present on a glass surface, in particular a rear window or a windscreen of a motor vehicle. The wiper system 4 comprises the drive arm 3 which is capable of carrying out an angular back-and-forth movement over and above the glass surface.

The wiper system 4 also comprises the wiper blade 1 which extends along a main axis which is referred to as the longitudinal axis X which is parallel with the axis Ox. The wiper blade 1 comprises at least one air deflector 5 and a scraper blade 6. The air deflector 5 is provided to convert a pressure applied by an air flow which flows over the glass surface into an abutment force of the wiper blade 1 against the glass surface of the motor vehicle. The scraper blade 6 is the component of the wiper blade 1 in direct contact with the glass surface in order to discharge the water and/or dirt present on the glass surface. The air deflector 5 and the scraper blade 6 form a semi-rigid assembly 7 which is carried by a connection device 8, which is interposed between the drive arm 3 and the semi-rigid assembly 7.

The connection device 8 ensures a mechanical connection between an end portion 9 of the drive arm 3 and the wiper blade 1 and thus allows separation of the wiper blade 1 from the drive arm 3 in order to replace the wiper blade 1. The present invention particularly relates to the provision of the adapter 2 which is arranged to facilitate such a replacement operation whilst effectively safeguarding the mechanical connection. In other words, the adapter 2 is particularly suitable for an after-sales market of the wiper blade 1.

In general terms, the connection device 8 of the present invention preferably comprises a total of two components, the adapter 2 and a connector 2, which can be seen together in FIG. 2, which illustrates the adapter 2 of the present invention in a position for use. In this position for use, the adapter 2 is fitted to the end portion 9 of the drive arm 3, in accordance with a method of the invention described below.

The connector 10 is capable of carrying the wiper blade 1 and is mounted for rotation on the adapter 2. The adapter 2 is provided to be fixed to the end portion 9 of the drive arm 3. According to an embodiment of the invention, the adapter 2 and the connector 10 are constructed by moulding from a synthetic material, for example, a material from the family of polyoxymethylenes, which is known by the acronym POM, or by moulding from an admixture of polymer materials, for example, an admixture of polymers of the family of polycarbonates and the family of acrylonitrile butadiene styrene, known by the acronym ABS. The adapter, on the one hand, and the connector 10, on the other hand, are preferably each integral. In other words, the adapter 2, on the one hand, and the connector 10, on the other hand, are monobloc and can be separated into a plurality of portions only on the basis of destruction of the adapter 2 or the connector 10. The end portion 9 is itself, for example, produced by bending a metal strip, such as a steel plate, aluminium plate or the like, or by moulding from a synthetic material.

With reference to FIGS. 3 to 5, the adapter 2 extends along the longitudinal axis X and comprises a front portion 11 and a rear portion 12 which are articulated to each other. The front portion 11 and the rear portion 12 are mutually successive along the longitudinal axis X and are aligned one after the other along the longitudinal axis X. The front portion 11 and the rear portion 12 are movable relative to each other about an articulation axis A1 which is orthogonal to the longitudinal axis X, the vertical axis Z and parallel with the transverse axis Y. In other words, the front portion 11 and the rear portion 12 are mounted in a hinged manner relative to each other about the articulation axis A1. The front portion 11 and the rear portion 12 are connected to each other by an articulation means 13 which is interposed between the front portion 11 and the rear portion 12 and which forms a connection means between the front portion 11 and the rear portion 12.

The front portion 11 of the adapter 2 comprises a body 14 and a front end 15. The body 14 is the part of the front portion 11 which is connected to the rear portion 12 by way of the articulation means 13. The body 14 is placed in an intermediate position between the front end 15 and the rear portion 12. The front end 15, which is otherwise called the head of the adapter, forms the extreme part of the front portion 11 which is located longitudinally opposite the rear portion 12. In other words, along the longitudinal axis X and from the rear of the adapter 2 in the direction towards the front thereof, there are successively arranged the rear portion 12, the articulation means 13, the body 14 and the front end 15.

The front portion 11 forms a fixed reference with regard to the rear portion 12, the rear portion being the portion of the adapter 2 which rotates about the front portion 11 by way of the articulation means 13.

The front portion 11 and the rear portion 12 each have a U-shaped transverse profile. In other words, in accordance with a cross-section taken in a plane of section parallel with the plane Oyz, the front portion 11 and the rear portion 12 comprise a U-shaped transverse profile. In other words, the front portion 11 comprises an upper wall 11a which forms the base of the “U” and two front lateral walls 11b, which are in particular parallel or substantially parallel with each other and orthogonal or substantially orthogonal to the front upper wall 11a, which form the legs of the “U” while the rear portion 12 comprises a rear upper wall 12a which forms the base of the “U” and two rear lateral walls 12b, which are substantially parallel with each other and substantially orthogonal to the rear upper wall 12a, which form the legs of the “U”.

The adapter 2 further comprises a rotation means which is provided to connect the adapter 2 to the connector 10, while allowing a rotation of one relative to the other. This rotation means allows this rotation about the transverse axis Y. The rotation means can be formed by a pair of strands which extend in the recessed structure of the adapter 2. They may also be bearings which are provided in the front lateral walls 11b.

Advantageously, the rotation means is arranged on the adapter 2 longitudinally between the front end 15 and the articulation means 13.

The front upper wall 11a and the rear upper wall 12a are advantageously connected to each other by the articulation means 13. In other words, the articulation means 13 is interposed between the front upper wall 11a and the rear upper wall 12a.

In FIG. 3, the adapter 2 is illustrated in the rest position while, in FIG. 4, the adapter 2 is illustrated in a position for use, that is to say, as the adapter 2 is illustrated in FIG. 2. In other words, in FIG. 3, the adapter 2 is generally illustrated, in the state as derived from the moulding, for example, while in FIG. 4 the adapter 2 is illustrated as if the adapter 2 were fitted to the end portion 9 of the drive arm 3, which has not been illustrated in FIG. 4 in order to make it easier to read. In FIG. 5, the adapter 2 is illustrated in an assembly position, which is intermediate between the rest position and the position for use.

The position for use is the position in which the adapter 2 is attached to the end portion 9, in particular during the wiping operations of the wiper blade 1. The rest position of the adapter 2 is the position in which it is separated from the end portion 9 and in which no force is applied to the rear portion 12. The assembly position of the adapter 2 corresponds to the position which the rear portion 12 takes up in relation to the front portion 11 in order to allow the introduction of a button 16 inside a hole 90 of the end portion 9 of the drive arm 3.

In FIG. 3, the front upper wall 11a and the rear upper wall 12a form a first angle α₁ which is not zero and which is preferably between 4° and 6°, preferably of 5°, while in FIG. 4 the front upper wall 11a and the rear upper wall 12a are co-planar and form a second angle α₂ which, in the present case, is substantially zero, as a result of the implementation of the method of the invention described below. According to another example of a position for use, the second angle α₂ can be different from 0°, while being positive or negative, it being understood that the second angle α₂ is less than the first angle α₁.

It will be noted that it is advantageous for the second angle α₂ to be less than the first angle α₁ while being different from 0°. In such a case, the rear portion 12 and the front portion 11 of the adapter 2 in a position for use extend in planes, between which the second angle α₂ is formed, this angle being, for example, between 1° and 4°. Such specificity allows the production of compensation for a longitudinal play between the adapter 2 and the end portion 9 of the drive arm 3.

The rear upper wall 12a is provided with the button 16 which emerges above the rear upper wall 12a. In other words, the button 16 overhangs the rear upper wall 12a while being positioned above a plane which is formed thereby. The button 16 is formed in order to be imbricated inside the hole 90 which the end portion 9 of the drive arm 3 comprises, as illustrated in FIG. 2. The button 16 comprises a tooth 17 which overhangs and extends above the rear upper wall 12a. Such a tooth 17 forms a rim extending from the button 16 which extends longitudinally forwards. In other words, the tooth 17 of the button 16 forms a protrusion. The button 16, in particular the tooth 17 thereof, is arranged to grip a thickness of a first wall 95 of the end portion 9 of the drive arm 3. It will be noted that the length of the button 16 increased by the tooth 17 thereof, measured in the longitudinal direction X, is less than a length of the hole 90 measured in the same direction. The button 16 provided with the tooth 17 thereof is thereby allowed to extend through the hole 90.

The front end 15 is provided with a hook 18 which at least partially overhangs the front upper wall 11a of the body 14. The hook 18 is preferably arranged at the same distance from each of the front lateral walls 11b. In other words, the hook 18 is preferably arranged in a longitudinal centre plane of the adapter 2.

The front lateral walls 11b and the rear lateral walls 12b are separated from each other by a through-hole 19 which extends between the articulation means 13 and a lower edge 20 of the adapter 2. The lower edge 20 is formed by the lower end of the front lateral walls 11b and the rear lateral walls 12b, this lower edge 20 being located opposite the front upper wall 11a and the rear upper wall 12a. The through-hole 19 allows the introduction of the front lateral walls 11b and the rear lateral walls 12b during a tilting movement 21 between the front portion 11 and the rear portion 12 about the articulation means 13. In other words, during the tilting movement 21 of the front portion 11 and/or the rear portion 12 about the articulation means 13, a rear rim 11c of the front portion 11 and a front rim 12c of the rear portion 12 are capable of moving towards each other or moving apart from each other as a result of a narrowing or a widening of the through-hole 19. The through-hole 19 is, for example, V-shaped. as illustrated in FIGS. 3 to 5. According to another embodiment illustrated in FIGS. 6 to 8, the through-hole 19 is capable of having a different formation, in particular an S-shaped formation.

In FIG. 3, the rear edge 11c and the front edge 12c form a third angle α₃ which is not equal to zero, preferably between 4° and 6°, preferably of 5°, while, in FIG. 4, the rear edge 11c and the front edge 12c form a fourth angle α₄ which is strictly less than the third angle α₃. The fourth angle α₄ defines the position for use.

In FIG. 5, it will be noted that, in the assembly position, the fourth angle may be zero, particularly when the rear edge 11c is in abutment with the front edge 12c. In this situation, a through-hole 19 arranged between these two edges is closed. The hole 19 is qualified as being a through-hole in the sense that it separates the front upper wall 11a from the upper wall 12a. The portion of through-hole 19 arranged between the front lateral wall 11b and the rear lateral wall 12b widens from the front upper wall 11a and rear upper wall 12a and in the direction towards the lower edge 20 of the adapter 2.

The adapter 2 is, for example, provided with a leg 22 which extends inside the through-hole 19 between the rear edge 11c and the front edge 12c in order to maintain the front portion 11 and the rear portion 12 at a maximum distance during the tilting movement 12 thereof relative to each other. To this end, the leg 22 has a length which is greater than a length of the through-hole 19 taken between a free end of the front edge 12c and a free end of the rear edge 11c along the longitudinal axis X, in a position for use of the adapter 2, as illustrated in FIG. 4. It may be noted that at least one of the legs 22 allows reinforcement of the resilient effect of the articulation means 13 while avoiding an exaggerated spacing between the rear edge 11c and the front edge 12c, such a spacing then becoming evident as an increase of the angle α1. The resilient effect also participates in the function of compensating for the longitudinal play between the adapter 2 and the end portion 9 of the drive arm 3. This is because at least one of the legs 22 urges the rear portion 12 towards the rest position thereof illustrated in FIG. 3.

Preferably, the leg 22 has a small thickness in order to confer on the leg 22 optimised flexibility which allows it to become deformed between the rest position of the adapter 2 illustrated in FIG. 3 and the position for use of the adapter 2 illustrated in FIG. 4.

The rear portion 12 is, for example, provided with an actuation means 23, an example of which is constituted by a plate which extends inside a plane which is parallel with the plane Oxy, when the adapter 2 is in a position for use, at the rear of the rear portion 12 and in a longitudinal direction. The actuation means 23 forms a gripping member of the adapter 2 of the rear portion 12 in order to tilt it between the rest position of the adapter 2 and the assembly position of the adapter 2. Such an actuation means 23 allows the assembly or separation of the adapter 2 with respect to the end portion 9 of the drive arm 3.

In FIGS. 6 to 8, a variant of the adapter 2 illustrated in the schematic FIGS. 3 to 5 is illustrated. According to this variant, the adapter 2 is not provided with a leg 22 or rear tongue 23.

In FIG. 6, the front end 15 is profiled towards the front of the adapter 2 in such a manner that the front end 15 has a height, taken between an upper wall 15a of the front end 11a and the lower edge 20 in accordance with the vertical axis Z, which decreases from the body 14 towards the front of the front end 15. The front end 15 forms a tip which longitudinally extends the end portion 9 so as to profile it.

Each front lateral wall 11b of the intermediate body 14 is provided with a finger 24 which extends above the front lateral wall 11b. Preferably, the finger 24 is in the form of a cylindrical portion which is arranged above a plane formed by the front lateral wall 11b of the intermediate body 14. The finger 24 is provided to slide inside a groove 91 which the end portion 9 of the drive arm 3 comprises. The diameter of the finger 24 is preferably less than a width of the groove 91 taken along the vertical axis Z in order to allow ease of sliding of the finger 24 in the groove 91.

At the edge of the front portion 11 and the front end 15, the front end 15 has a first vertical height H1, taken between the upper wall 15a of this end and the lower edge 20 of the adapter 2 in the direction Oz which is greater than a second vertical height H2 of the body 14, taken between the front upper wall 11a and the lower edge 20 of the adapter 2 in the same direction Oz. In other words, the front end 15 is higher than the first portion 11 of the adapter 2, this height difference being, for example, equal to a thickness of the end portion 9 of the drive arm 3. In a complementary manner, the front end 15 also projects above the first portion 11, at least partially overlapping the portion longitudinally.

With reference to FIG. 7, at the edge of the front portion 11 and the front end 15a, the front end has a first transverse width L1, taken between the front lateral walls 11b of the front end 15 along the transverse axis Y, which is greater than a second transverse width L2 of the body 14, taken between the front lateral walls 11b, along the transverse axis Y. As a result, the front end 15 comprises a border 25 which emerges above the front upper wall 11a of the body 14. In other words, the front end 15 is wider than the first portion 11 of the adapter 2. In a complementary manner, the front end 15 also projects at each side of the first portion 11. This width difference is, for example, twice the thickness of the wall which constitutes the end portion 9 of the drive arm 3.

The border 25 constitutes a stop counter to a front edge 92 which the end portion 9 of the drive arm 3 comprises.

The border 25 is provided with the hook 18. The hook 18 is equally well a protuberance from the upper wall of the front end 15, as illustrated in FIGS. 3 and 4, or an extension of this upper wall from the border 25, as illustrated in FIGS. 6 to 8.

The border 25 comprises at least a first nesting member 26 which has a formation which complements at least a second nesting member 93 which the front edge 92 of the end portion 9 of the drive arm 3 comprises. The first nesting member 26 and the second nesting member 93 cooperate with each other in order to facilitate the border 25 and the front edge 92 being placed in contact and placed in abutment.

According to the embodiment illustrated, there are two first nesting members 26 which are fitted to the front lateral walls 11b, respectively. Alternatively, the nesting member 26 may be a single member on the adapter 2. Each first nesting member 26 is, for example, in the form of a semi-circular bulge in order to cooperate with the second nesting member 93 which an opening of the groove 91 constitutes. The first nesting member 26 and the second nesting member 93 together prevent vertical displacement of the adapter 2 with respect to the end portion 9 of the drive arm 3, in a position for use of the adapter 2.

The nesting member(s) 26 are advantageously vertical blocking means of the adapter 2 in the end portion 9 of the drive arm 3.

The rear portion 12 comprises at least one ramp 31, and in particular two ramps 31 which are arranged vertically in the rear lateral walls 12b, respectively. Each of the ramps 31 extends in a plane which is substantially parallel with the plane Oyz. The ramps 31 each delimit a groove 33 which is arranged in the lateral walls 12b.

In FIG. 7, the articulation means 13 is, for example, formed by at least one bar 27 which connects the front portion 11 and the rear portion 12. The articulation means 13 in particular comprises two contiguous bars 27 which are spaced apart from each other by an opening 28. Each bar 27 is, for example, formed by a plate having a small thickness E taken along the vertical axis Z. The articulation means 13 is simple to produce, in particular during the moulding of the adapter 2, a thickness E of the articulation means 13 (visible in FIG. 6) being, for example, less than 15% of the second height H2, the thickness E being taken along the vertical axis Z between upper and lower edges of the bars 27. Such a small thickness of the bars 27 confers a flexibility on the articulation means 13 which allows the articulation of the rear portion 12 with respect to the front portion 11.

There can be seen, in FIG. 7, the U-shaped cross-section which the adapter 2 according to the invention can take up. This U-shaped cross-section is formed by the rear upper wall 12a of the rear portion 12 and the lateral walls 12b, and by the front upper wall 11a and the front lateral walls 11b. This U-shaped form delimits an internal volume 32 which is arranged in order to at least partially receive the connector 8 which is fixedly joined to the wiper blade 1.

This internal volume may also receive a tongue 29 which is produced by moulding the rear portion 12, for example, with the rear upper wall 12a of the rear portion 12. The tongue 29 is provided to come into contact against the connector 8 in a position for use of the adapter 2. Such a tongue 29 forms a device for securing the mechanical connection between the adapter 2 which is installed in the end portion 9 of the drive arm 3. This is because, once the adapter 2 is installed in the end portion 9, the tongue 29 blocks the tilting of the rear portion 12 relative to the front portion 11, which prevents the button 16 from leaving the hole 90, for example, when a traction is applied to the drive arm while the wiper blade 1 is retained on the windscreen by ice, for example.

In FIGS. 9 and 10, the end portion 9 of the drive arm 3 is arranged in a “U” shape, when viewed as a cross-section parallel with the plane Oyz. The end portion 9 comprises a first wall 95 which forms the base of the “U” and two second walls 96 which are substantially parallel and which form the legs of the “U”.

The first wall 95 is provided with the hole 90, the hole 90 being centered laterally with respect to the first wall 95 of the end portion 9. The first portion 95 and the second walls 96 are partially delimited in the front portion by the front edge 92 which has a U-shaped transverse profile.

The front edge 92 is provided with the two grooves 91 which are arranged longitudinally inside the second walls 96. The two grooves 91 are arranged opposite each other through a second respective wall 96. Each groove 91 comprises an opening 93 which is provided in the front edge 92 in order to allow the introduction of a finger 24 of the adapter 2, respectively.

The second walls 96 each comprise an internal surface 97 which delimits, with the first wall 95, an internal volume 99 of the end portion 9. Each internal surface 97 is provided with a stud 98 which extends from the internal surface 97 towards the internal volume 99. Each stud 98 is, for example, arranged in a cylinder having an axis perpendicular to the internal surface 97. It will be noted that the two studs 98 are located at the same distance from the front edge 92 so that a straight line extending through the centre of these two studs 98 is parallel with the transverse axis Y.

The studs 98 are, for example, arranged at the rear of the grooves 91. In other words, each groove 91 is aligned with a respective stud 98 along the longitudinal axis X. Furthermore, the hole 90 and the studs 98 are in particular arranged inside a transverse plane which is parallel with the plane Oxy in such a manner that the hole 90 vertically overhangs the studs 98.

In FIG. 11, an assembly method for the adapter 2 with an end portion 9 of the drive arm 3 comprises a first step 101 for moving the hook 18 of the adapter 2 and the front edge 92 of the first wall 95 of the end portion 9 into abutment. Thus, the first wall 95 becomes received between the hook 18 and the front upper wall 11a of the front portion 11.

According to a second step 102 of the method, there is provision for rotation of the adapter 2 on the end portion 9 about a second rotation axis A2 which is substantially parallel with the transverse axis Y and which extends through a contact point between the hook 18 and the front edge 92, as moved towards each other during the first step 101. This rotation is brought about until the button 16 is arranged in alignment with the hole 90.

At this stage of the assembly method, the blocking of the adapter 2 in the end portion 9 can be brought about in accordance with two alternative or cumulative steps.

According to one of these alternatives, the method comprises a third step 103 which involves applying a force to the rear portion 12 so as to move it nearer the front portion 11 by way of the articulation means 13. Such a force can be applied by applying a manual pressure to the rear plate 23. This third step 103 leads to a reduction from the first angle α₁ to the second angle α₂ (FIG. 4) and to a reduction from the third angle α₃ to the fourth angle α₄ (FIG. 4). The through-hole 19 is then closed, which leads to the button 16 being moved longitudinally towards the front end 15. This longitudinal displacement of the button 16 displaces the tooth 17 so as to allow it to be introduced into the hole 90. In a summarised manner, the third step 103 involves manual locking of the adapter 2 in the end portion 9.

According to the other alternative, the method comprises a fourth step which involves automatic locking of the adapter 2 in the end portion 9. By continuing the rotation started in the second step 102, the studs 98 are introduced into the grooves 33. By doing this, the studs 98 move into abutment with the ramps 31 of the adapter 2 and slide against the ramps. This abutment brings about a force which generates an alignment of the front upper wall 11a with the rear upper wall 12a, leading to a reduction from the first angle α₁ to a second angle α₂ (FIG. 4) and a reduction from the third angle α₃ to the fourth angle α₄ (FIG. 4). The through-hole 19 is then closed which leads to the button 16 being moved longitudinally towards the front end 15. This longitudinal displacement of the button 16 displaces the tooth 17 so as to allow it to be introduced into the hole 90. This results in the rear portion 2 which tends to take up the rest position thereof in which the front upper wall 11a and the rear upper wall 12a form the first angle α₁ being placed under constraint.

According to a fifth step 105, the rotation carried out during the second step 102 is continued so that the tooth 17 overcomes the first wall 95 and is located above it. Once the rear upper wall 12a is in abutment with an internal face of the first wall 95 of the end portion 9, there is brought about contact of the button 16 against the front transverse edge 94 of the hole 90, on the basis of a natural tendency of the rear portion 12 to take up its rest position when the flexion force is interrupted and/or by means of one or more legs 22.

In such a case, the position for use involves the second angle α₂ being less than the first angle α₁ while being different from 0°. A length difference between a first distance separating the border 25 and a front lateral face of the button 16 and a second distance separating the front transverse edge 94 of the hole 90 from the front edge 92 of the end portion 9 represents the longitudinal play set out above. The presence of this play may become evident as unpleasant noises or vibrations. The compensation for this play brought about by the presence of a non-zero angle between the front upper face 11a and the rear upper face 12a in a position for use allows elimination of these disadvantages. It is possible to consider that the adapter 2 of the invention comprises a device for compensating for longitudinal play which is provided to limit a longitudinal movement between the adapter 2 and the end portion 9 of the drive arm 3.

In all cases, there is thus produced optimised locking of the adapter 2 in the end portion 9 and prevention of inadvertent unlocking of the adapter 2 fitted to the end portion 9 of the drive arm 3, in particular during the use of the wiper system 4 which is moved over the glass surface.

The disassembly of the adapter from the end portion 9 of the drive arm is carried out in accordance with the transposed steps with respect to those described above, in exchange for abutment against the button 16 which produces a rotation of the rear portion and displaces the tooth 17 so as to allow it to leave the hole 90.

1. An adapter configured to be fitted to an end portion of a drive arm, the adapter comprising:
at least one front portion, at least one section of which is arranged in a U-shaped manner and which comprises a front upper wall and two front lateral walls; and
at least one rear portion, at least one section of which is arranged in a U-shaped manner and which comprises a rear upper wall and two rear lateral walls,
wherein the front portion and the rear portion are articulated to each other by way of an articulation means which is interposed between the front upper wall and the rear upper wall.

2. The adapter according to claim 1, wherein the front portion and the rear portion are aligned in accordance with a longitudinal axis of the adapter.

3. The adapter according to claim 1, wherein the front portion comprises a body and a front end, the body being connected to the rear portion by way of the articulation means.

4. The adapter according to claim 3, wherein the front end and the body are delimited by a border which overhangs the body.

5. The adapter according to claim 4, wherein the border is provided with at least one hook.

6. The adapter according to claim 1, comprising a rotation means which is configured to connect the adapter to a connector.

7. The adapter according to claim 1, wherein the rear upper wall is provided with a button which is provided with a tooth.

8. The adapter according to claim 1, wherein at least one rear lateral wall is provided with a groove which is delimited at least by a ramp.

9. The adapter according to claim 1, wherein the adapter is provided with an actuation means for the rear portion.

10. A connection device formed by a connector and an adapter according to claim 1.

11. A drive arm comprising:
at least one end portion which is U-shaped and which is delimited by a first wall and by two second walls which delimit an internal volume for receiving an adapter according to claim 1.

12. The drive arm according to claim 11, wherein the first wall is provided with a receiving hole for a button which is provided with a tooth, the hole comprising a front transverse edge against which the button abuts, the tooth extending above the first wall.

13. A wiper system comprising a drive arm; a connector which is fixedly joined to a wiper blade; and an adapter according to claim 1 which connects the connector to the drive arm for rotation.

14. An assembly method for an adapter according to claim 1 with an end portion of a drive arm, the assembly method comprising:
a first step of placing a border of the adapter in contact against a front edge of a first wall of the end portion,
a second step which involves a rotation of the adapter with respect to the end portion about the contact between the border and the front edge carried out during the first step; and
a fifth step in which a tooth of a button of the adapter overcomes the first wall and extends thereabove.

15. The assembly method according to claim 14, during which there is provision between the second step and the fifth step alternatively or cumulatively for:
a third step which involves manual locking of the adapter in the end portion; and
a fourth step which involves automatic locking of the adapter in the end portion.
